(19) United States
(12) Patent Application Publication
(10) Pub. No.: US 2012/0139735 A1
(43) Pub. Date: Jun. 7, 2012

(54) VENDING MACHINE

(75) Inventors: Sander Dollner, Ulm-Wiblingen (DE); Frank Goeltenboth, Blaustein (DE); Alexander Kiefer, Kuchen (DE); Armin Startz, Weidenstetten (DE)

(73) Assignee: WMF WUERTTEMBERGISCHE METALLWARENFABRIK AG, Geislingen/Steige (DE)

(21) Appl. No.: 13/307,044

(22) Filed: Nov. 30, 2011

(30) Foreign Application Priority Data
Dec. 3, 2010 (DE) 10 2010 062 397.0

(51) Int. Cl. G08B 21/00

(52) U.S. Cl. 340/612

(57) ABSTRACT

A vending machine has at least one sensor to record at least one capacitive variable. The at least one sensor is formed as a wireless signal transmission chip, particularly a RFID chip (Radio Frequency Identification). Thus, a particularly precise and reproducible record of measurement results is possible, while permitting reduced cabling needs in view of the wireless signal transmission.

### BACKGROUND OF THE INVENTION

1. Field of the Invention

The present invention relates to a vending machine comprising at least one sensor to capture at least one capacitive variable.

2. Description of the Related Art

Drinks machines and particularly coffee machines are provided with numerous sensors recording particularly filling levels, for instance of a water tank, and transmitting the sensed data to a control device. In this regard, so called capacitive sensors also are used and operate based on the modification of the capacity of a single capacitor or a whole capacitor system. The sensors currently used for this purpose are generally wired up, wherein particularly capacitive sensors require an exact positioning of the medium to be measured relative to the sensor in order to deliver precise and reproducible results. If the sensors are used together with removable components, as for instance on a water tank or a milk storage tank, very high requirements have to be met by the coupling or the design of the measuring point, in order to obtain the above mentioned precise and reproducible measurement results.

The present invention therefore deals with the problem of indicating an improved or at least alternative embodiment for a generic vending machine that is constructed simply and delivers at the same time high quality measurement results.

### SUMMARY OF THE INVENTION

The present invention is based on the general idea of forming a capacitive sensor in a vending machine as a wireless chip for signal transmission, particularly as a RFID chip or of coupling it with such a chip for signal transmission, wherein this RFID chip is capable of wireless signal transmission and thus can be integrated directly on the measuring point. The capacitive sensor records a modification of the capacity of a single capacitor or a whole capacitor system and wirelessly transmits the so recorded measurement value, for instance to a control and steering device or a display panel. The term vending machine means a machine for dispensing solids as well as a machine for dispensing liquids, pastes, or mixtures. This is particularly advantageous if the sensor shall record for instance the filling level of a removable water tank, as in this case the wireless signal transmission chip can be securely mounted directly on the container. Furthermore, by means of wireless signal transmission via certain frequencies, an otherwise high cabling need can be avoided inside of the vending machine. However, the biggest advantage is that particularly the sensor formed as a RFID chip always is positioned correctly relative to the medium to be measured due to its once fixed position and thus delivers particularly precise results.

For previous sensors which should record the filling level of for instance a removable water tank, this was only possible by a very precise coupling or design of the measurement point. By using the signal transmission chip according to the invention, the problem of the optimal relative position between the sensor and the medium to be measured is solved, as the wireless signal transmission chip is once arranged on its installation position and mounted there. Particularly, it is thus also imaginable for the signal transmission chip to be integrated into a wall and thus be removed together with it and cleaned.

The English term RFID (Radio Frequency Identification) means identification using electromagnetic waves and thus permits an automatic identification or localization, for instance of variables or objects to be measured, as for instance a filling level in a water tank. A RFID system is generally formed of a RFID chip (transponder) on the object and characterizes it, as well as a reading machine to read out the transponder identification. The reading machine, which is in the present case integrated into the drinks machine, generally comprises a software controlling the actual reading process. Generally, the reading machine thus generates an electromagnetic high frequency field with limited range, preferably by using induction coil, whereby not only data can be transmitted, but the RFID chip can also be supplied with energy at the same time. The used RFID chips can be as little as a grain of rice and thus be positioned without difficulties on almost all important spots of the drinks machine.

### DETAILED DESCRIPTION OF THE PREFERRED EMBODIMENTS

In a favorable further development of the solution according to the invention, the signal transmission chip is arranged on at least one of the following containers and identifies its presence or a filling level in this container: beans container, coffee powder container, filter coffee container, cleaner container, milk storage container, coffee ground container, water tank, mix fluid container and/or drip tray. Mix fluid here means particularly syrup, alcohol, cream, milk, colors etc. Naturally, such a signal transmission chip can also be used to detect leakages or to monitor a functioning control (for instance is a tube/pipe filled or not). When seeing the enumeration, it is already perceivable how large the possible area of application of such a wireless signal transmission chip in vending machines and particularly in coffee machines or fully automated coffee machines is.

In another favorable embodiment of the solution according to the invention, the at least one signal transmission chip is an integral component of the container. Here, the signal transmission chip can for instance be integrated, particularly injected into the wall of a water tank, and thus be removed together with the water tank or be cleaned together with it. Due to the integrated position of the signal transmission chip in for instance the wall of the container, it is also protected against external influences, so that a high level of functional safety can be reached. Naturally, the signal transmission chip should not only be considered for capacitive work or for recording capacitive variables, but it can generally operate differently.

Appropriately at least one signal transmission chip is arranged to record for instance a flow, a pressure, a rotational speed, a route/distance, a moisture content, a density or to detect water substances. This enumeration again permits understanding that the signal transmission chip (RFID chip) according to the invention can be used to record almost any variable inside of the drinks machine, i.e. particularly an automatic coffee machine of a coffee machine. Naturally, this enumeration is not considered to be exhaustive, so that other factors or other installation positions not mentioned before can be provided for the signal transmission chip according to the invention.

The wireless signal transmission chip according to the invention allows particularly coffee machines to be equipped with such parts that have to be removed and rearranged frequently, wherein the signal transmission chip preferably is mounted securely in or on the removable part. Thus it is guaranteed that the signal transmission chip is always positioned in the same way relative to the medium to be measured and thus provides reliable and precisely reproducible results. By means of wireless signal transmission, it is also possible to have a multitude of in particular RFID chips read by only one reading machine, so that particularly the cabling needs can be considerably reduced due to wireless transmission. Thus, the drink machines according to the invention are not only constructed more simply and cheaper, but also more maintenance friendly.

### BRIEF DESCRIPTION OF THE DRAWINGS

FIG. 1 is a schematic view of a vending machine in accordance with the invention.

FIG. 2 is an exploded schematic view of the vending machine shown in FIG. 1.

### DETAILED DESCRIPTION OF THE PREFERRED EMBODIMENTS

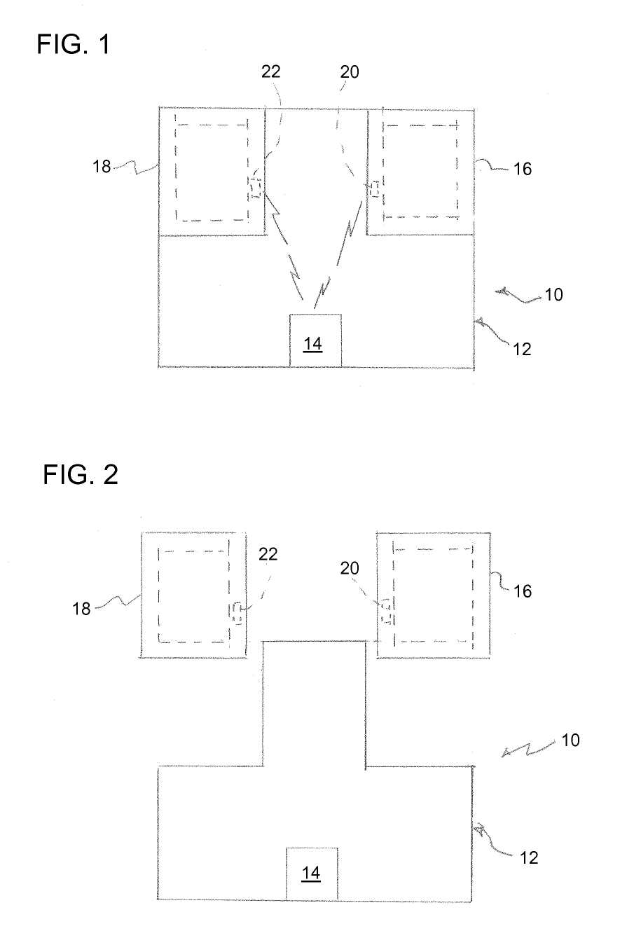

A vending machine in accordance with the convention is identified by the numeral 10 in FIGS. 1 and 2. The vending machine 10 has a housing 12 that includes operative components for dispensing a product, such as coffee. The operative components may include pumps, heaters, grinders, wiring, pipes, payment receivers and the like, none of which are illustrated, and all of which may be of conventional design. The operative components are controlled by a control unit 14 that is configured to generate and/or received signals wirelessly.

The vending machine 10 further includes containers 16 and 18 that are mounted removably to the housing 12. The container 16 may be provided to contain a liquid, such as water. The container 18 may be provided to contain a powder, such as sugar, or a granular product such as ground coffee or coffee beans. The containers 16 and 18 can be removed from the housing 12 for replacement, refilling or cleaning.

The containers 16 and 18 may be molded unitarily from a synthetic resin to include an array of interconnected walls and at least one signal transmission chip 20, 22 is secured fixedly to at least one wall of each container 16, 18. More particularly, the signal transmission chip 20, 22 preferably defines an insert about which the walls of the respective container 16, 18 are molded. Thus, the signal transmission chip 20, 22 is positioned accurately in the respective container 16, 18 and is protected from external influences, such as moisture. Preferably, each signal transmission chip 20, 22 is a RFID chip that is capable of communicating wirelessly with the controller 14. It will be appreciated that the signal transmission chips 20, 22 are illustrated as being relatively large in FIGS. 1 and 2. However, these relative dimensions are intended merely for illustrative purposes and the actual signal transmission chips 20 and 22 will be much smaller as compared to the size of the corresponding containers 16, 18. The signal transmission chips may be operative to generate signals indicative of the presence of the respective container 16 and 18 in position on the housing 12. Additionally or alternatively, the signal transmission chips 20, 22 may be operative for generating signals indicative of the level of material filled into the corresponding containers 16, 18 or characteristics relating to the material in the respective container 16, 18. The signals produced by the signal transmission chips 20, 22 may relate to moisture content, temperature, flow rates, pressure or the like in the container 16, 18. One signal transmission chip 20, 22 is illustrated as being associated with each container 16, 18. However, plural signal transmission chips 20, 22 may be provided for each container 16, 18. Additionally, two containers are illustrated in FIGS. 1 and 2. However, only one container may be provided or several containers may be provided.

What is claimed is:

1. A vending machine comprising at least one sensor to record at least one capacitive variable, characterized in that the at least one sensor is formed as a wireless signal transmission chip.

2. The vending machine of claim 1, wherein the wireless signal transmission chip is a RFID chip.

3. The vending machine of claim 2, wherein the vending machine is a drinks machine and the signal transmission chip is arranged on a container of the drinks machine to identify a filling level in the container or a presence of the container in the vending machine.

4. The vending machine of claim 3, wherein the container is a beans container, a coffee powder container, a filter coffee container, a topping/chocolate milk powder/cleaner container, a milk storage container, a coffee ground container, a water tank, a mix fluid container or a drip tray.

5. The vending machine of claim 3, wherein the signal transmission chip is an integral component of the container.

6. The vending machine of claim 3, wherein at least one signal transmission chip is operative to record a flow, a pressure, a rotational speed, a route/distance, a moisture content, a density or to detect water substances.

7. The vending machine of claim 3, wherein the container is removable from the drinks machine.

8. The vending machine of claim 3, wherein the drinks machine is a coffee machine or an automatic coffee machine.
